(19) United States
(12) Patent Application Publication
(10) Pub. No.: US 2017/0006837 A1
(43) Pub. Date: Jan. 12, 2017

(54) APPARATUS FOR DETECTING DEAD ANIMALS IN A FARM AND METHOD OF DETECTION WITH SUCH APPARATUS

(71) Applicant: EXORAO S.R.L., Sassuolo (IT)

(72) Inventors: Davide BALZANI, Fiorano Modenese (IT); Stefano BERTELLI, Sassuolo (IT)

(73) Assignee: EXORAO S.R.L., Sassuolo (IT)

(21) Appl. No.: 15/119,139

(22) PCT Filed: Feb. 13, 2015
(86) PCT No.: PCT/EP2015/053132

§ 371 Date: Aug. 16, 2016

(30) Foreign Application Priority Data
Feb. 17, 2014 (IT) PD2014A000031

(51) Int. Cl. A01K 29/00; G01B 11/00

(52) U.S. Cl. CPC A01K 29/005; G01B 11/002

(57) ABSTRACT

An apparatus for detecting dead animals in a farm, particularly for farms of laying hens, comprising one or more scanning elements arranged, with a corresponding supporting structure, so as to map the space of a farm, the scanning elements being connected to an electronic control and management unit) that is adapted to process the scans, detecting any presence of motionless animals in the farm space. A method of detecting dead animals in a farm by way of such an apparatus comprises the steps of performing periodically a mapping of the space of the farm intended to be occupied by animals raised there, comparing successive mappings in order to identify any animals that are in the same position in at least two successive mappings, and emitting a signal indicating the presence of a motionless animal.

The present invention relates to an apparatus for detecting dead animals in a farm, particularly for farms of laying hens.

The invention also relates to a method of detecting dead animals which is carried out with such apparatus.

Nowadays, there are thousands of installations worldwide for the intensive farming of small animals, such as hens, rabbits, and the like.

In these farms, while operations such as feeding and the collection of feces are generally automated, monitoring the deaths of the animals is almost always assigned to human personnel, since no effective detection systems exist.

For obvious reasons of hygiene, it is essential that any deaths be detected within a maximum amount of time, generally established at twenty-four hours, in order to prevent the decomposition of the dead bodies from infecting the other animals or the food products, as in the case of the production of eggs.

For this reason all cages must be inspected daily by the personnel, who have to identify and promptly extract any dead animals.

Entrusting this monitoring task exclusively to human personnel, in addition to the economic burden, entails the inevitable risks of a routine job: often the dead bodies are not identified within the preset time, with evident problems of hygiene and health.

The aim of the present invention is to provide an apparatus for detecting dead animals in a farm, which is capable of overcoming the limitations of monitoring carried out by human personnel.

Within this aim, an object of the invention is to provide a method of detecting dead animals which is carried out with such an apparatus.

Another object of the invention is to provide an apparatus that can operate automatically, with precision, reliably and efficiently, without particular interventions by human personnel, except for management and supervision.

Another object of the invention is to provide an apparatus, as well as a method for its use, that can also be applied easily to already-existing farms.

This aim and these and other objects which will become more evident hereinafter are achieved by an apparatus for detecting dead animals in a farm, particularly for farms of laying hens, characterized in that it comprises one or more scanning means arranged, with a corresponding supporting structure, so as to map the space of a farm, said scanning means being connected to an electronic control and management unit that is adapted to process the scans, detecting any presence of motionless animals in said farm space.

Advantageously, a method of detecting dead animals in a farm by way of an apparatus as described above is characterized in that it comprises the following operations:
performing periodically a mapping of the space of the farm intended to be occupied by animals raised there,
comparing successive mappings in order to identify any animals that are in the same position in at least two successive mappings,
emitting a signal indicating the presence of a motionless animal.

Further characteristics and advantages of the invention will become more apparent from the description of a preferred, but not exclusive, embodiment of the apparatus according to the invention, which is illustrated by way of non-limiting example in the accompanying drawings wherein:

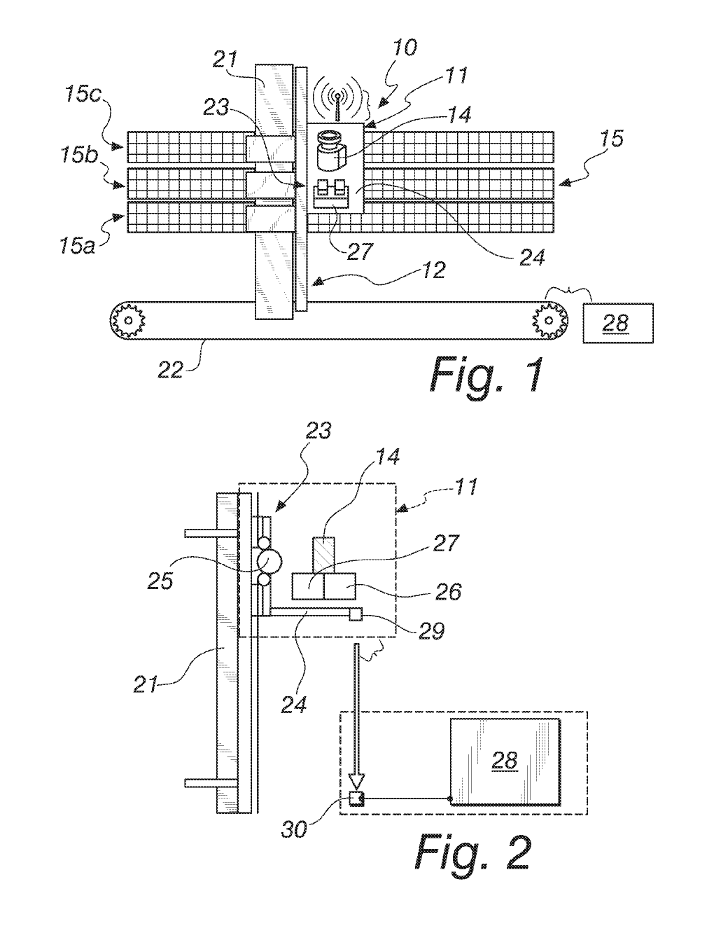

FIG. 1 is a schematic side view of a system for farming laying hens, which is fitted with an apparatus according to the invention,

FIG. 2 is a schematic front elevation view of an apparatus according to the invention;

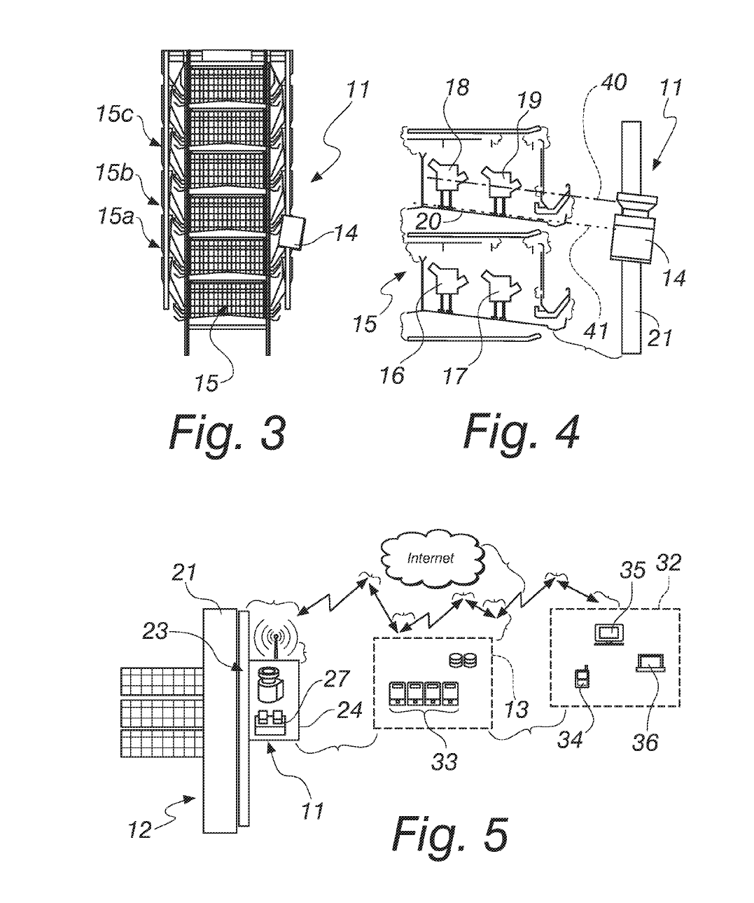

FIG. 3 is a schematic front elevation view of a system for farming laying hens, which is fitted with an apparatus according to the invention,

FIG. 4 is a schematic view of the operation of an apparatus according to the invention;

FIG. 5 is a schematic view of a data management system for an apparatus according to the invention,

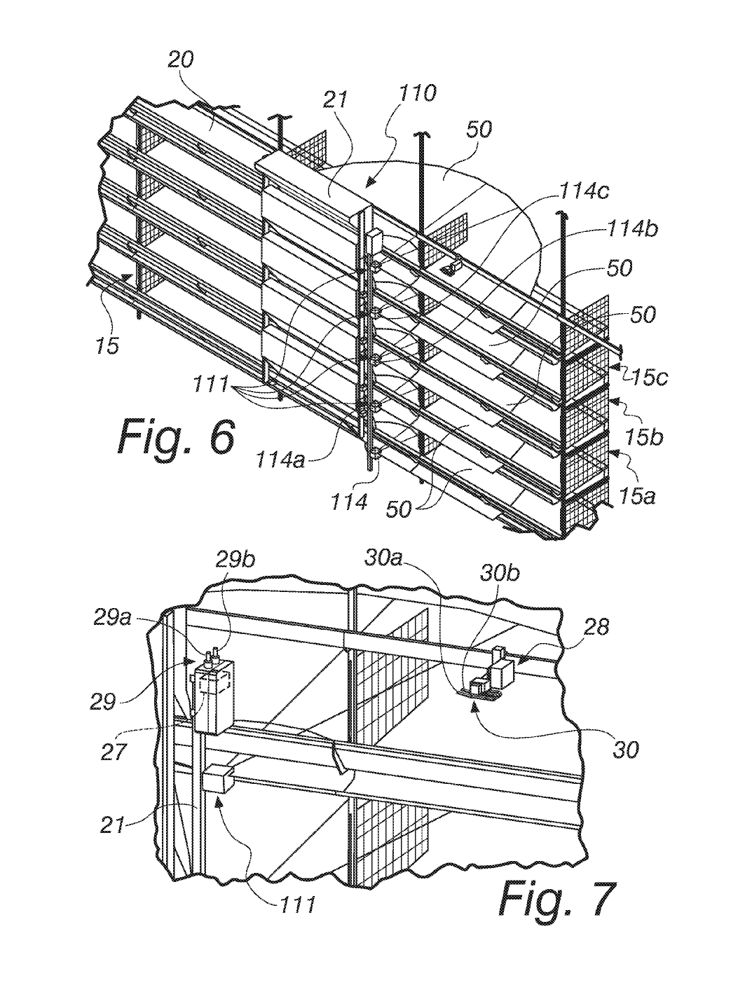

FIG. 6 is a perspective view of a system for farming laying hens, which is fitted with an apparatus according to the invention, such apparatus being a variation of embodiment thereof;

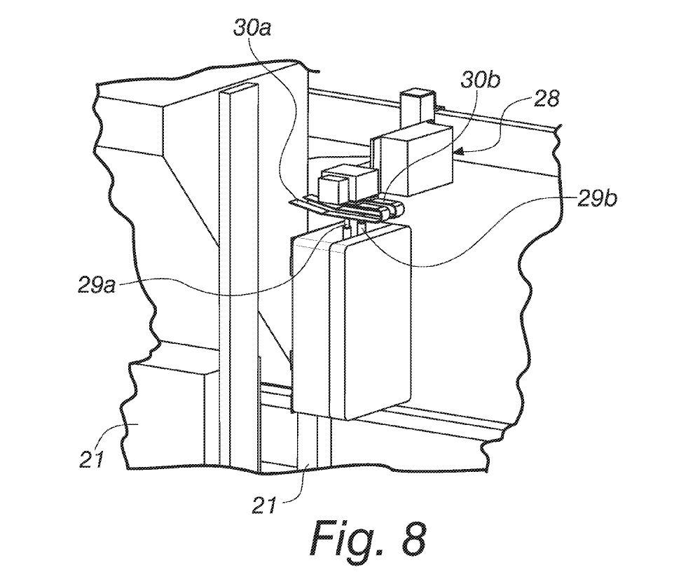

FIGS. 7 and 8 are schematic views of a detail of an apparatus according to the invention in two different steps of use.

With reference to the figures, an apparatus for detecting dead animals in a farm, particularly for farms of laying hens, according to the invention, is generally designated with the reference numeral 10.

Such apparatus 10 comprises one or more scanning means, one of which is designated with the reference numeral 11 in FIG. 1.

The scanning means 11 are positioned, by way of a corresponding supporting structure 12 described in more detail hereinbelow, so as to map the space of a farm.

The scanning means 11 are connected to an electronic control and management unit 13 that is adapted to process the scans, detecting any presence of motionless animals in said farm space.

The scanning means 11 are constituted, for example, by one or more telemetry measurement sensors 14, such as, again for example and specifically, one or more two-dimensional laser scanners.

The term ‘telemetry measurement sensor’ is used to indicate a sensor that is capable of detecting the distance of solid bodies by emitting rays whose path can be established.

The term ‘two-dimensional laser scanner’ is used to indicate a device that is capable of detecting solid bodies within its range, by way of the reflection of a series of laser beams

When a single beam is reflected by a body, the sensor detects its angle and distance, measuring its airborne time (using the principle of sonar).

The scanning thus returns a series of two-dimensional polar coordinates, which are arranged on the detection plane of the sensor.

By way of non-limiting example of the invention, the apparatus 10 according to the invention is described in application to a typical poultry farm system for the production of eggs; it should be understood that the invention naturally can be applied to any type of fanning, by adapting the installation to the characteristics of the system.

The hens live inside cages, with a space that varies from 550 cm² to 750 cm² of available space per hen.

The cages, which are generally designated with the reference numeral 15 in the figures, are arranged side by side so as to constitute rows of cages several dozens of yards in length, arranged on multiple levels, for example 15a, 15b and 15c.

The figures show some outlines of hens, indicated with the reference numerals 16, 17, 18 and 19.

The floor 20 of the cages 15 is inclined, in order to allow the eggs laid to roll toward an external conveyor belt.

In the present embodiment, the scanning means 11 are constituted by a single telemetry measurement sensor 14, for example a two-dimensional laser scanner.

The term ‘laser scanner’ is used to indicate, as mentioned above, any sensor that emits a laser beam and is capable of returning the distance of the point detected thanks to the measurement of the airborne time of the reflected beam; this type of analysis differs considerably from other systems such as artificial vision, in that it makes it possible to analyze the space occupied instead of images produced from the environment.

The supporting structure 12 is constituted, for example, by a post-like element 21 that is arranged so as to translate in proximity to the levels of cages 15a, 15b and 15c and in the direction of their length.

The post-like element 21 is moved for example by way of belt or chain means 22, or with other, equivalent means, which should be understood as being of a conventional type.

Such post-like element 21 in turn supports means 23 for translation from top to bottom, and vice versa, of the two-dimensional scanning means 11, i.e. for the telemetry measurement sensor 14.

Such means 23 for translation from top to bottom and vice versa are constituted, for example, by a carriage 24 with an electric gearmotor 25 on board which is adapted to drive a toothed belt with an omega-shaped path.

Alternatively, such means for translation from top to bottom and vice versa are constituted by a carriage 24 with an electric gearmotor 25 on board which is adapted to drive a rack-and-pinion system.

The carriage 24 supports, together with and in addition to the telemetry measurement sensor 14, an electronic unit 26 for managing the detected signals and the movement by way of a gearmotor 25, and an onboard battery 27 that is adapted to supply power to the scanning means 11, i.e. the telemetry measurement sensor 14, electronic unit 26 and gearmotor 25.

In proximity to a stroke limit of the post-like element 21 there is a battery charger 28 for the onboard battery 27.

At the end of a detection cycle the apparatus 10 is programmed to move the carriage 24, which is provided with an energy transfer system 29 for charging the onboard battery 27, for example an electrical contact, such that this electrical contact is connected to a second electrical contact 30 that is associated with the battery charger 28.

In this manner, the onboard battery 27 is recharged during the periods when no detection is performed.

In many systems for farming hens, the distribution of fodder is performed by way of a column on which as many hoppers are installed as there are levels of cages.

The hoppers are loaded with the fodder in a preset starting position, and are moved by way of a chain, which is actuated by a motor located on one of the two sides in a fixed position.

Such column, with its movement means, lends itself well to the use of the apparatus 10 according to the invention as described above.

In fact in this type of system, by installing the telemetry measurement sensor 14 on board a column, it is possible to obtain the mappings by taking advantage of the periodic translation of the column, the movement of which makes it possible both to reach all the cages and to obtain multiple scans of the same area from different angles.

The data detected by the sensor are transmitted via radio to a remote system, i.e. the electronic control and management unit 13, which processes its information and informs the personnel of the outcome of the analysis, with a means of communication 32 that can be conventional, for example via mobile phone, or via computer.

The data coming from the telemetry measurement sensor 14 are locally recorded and compressed, by the onboard electronic unit 26.

At the end of the translation of the post-like element 21, the onboard electronic unit 26 establishes a wireless connection to a server 33 that can be reached by way of a public internet address.

The server 33 picks up all the data collected, processes them and make them available on the web by way of any internet consultation device, for example a mobile phone 34, a personal computer 35 or a portable computer 36.

The supporting structure 12, thanks to the means for translation, in parallel to the direction of the length of the cages 15, of the post-like element 21, and thanks to the means 23 for translation from top to bottom and vice versa for the carriage 24, makes it possible to use a single telemetry measurement sensor 14, moved in a preset manner.

The basic premises underlying the logic of operation of the apparatus 10 according to the invention are as follows.

A healthy animal never stays still in the same point for long periods of time, but moves around to eat, drink, defecate or simply due to the dynamics deriving from sharing the same space with other animals

Starting from this consideration, the apparatus 10 is designed to periodically perform a two-dimensional mapping of the outlines of animals that are not moving.

A certain area is ascertained to be free when one or more beams can pass through it. The areas through which no beam passes define, as a consequence, the outlines of animals that are not moving.

By then suitably comparing the sequence of mappings, outlines that are motionless for a determined period of time are reported as possibly dead animals.

The “dead animal” report is made by specifying the absolute position of the animal in the farm; such report is sent to an operator who is thus called on to go and remove the dead animal

The report is ended only when, in a subsequent mapping, the motionless outline no longer appears.

All the data recorded by the system, like the positions of the dead bodies and the removal times, are logged in a history file, so that they can be consulted subsequently.

By way of a single scan it is not possible to obtain a complete picture of the situation, mainly for two reasons:
it is not possible to establish whether the outlines detected are in motion,
it is not possible to detect outlines that are covered by what is called a “shadow cone” of other outlines, as shown for the purpose of example in FIG. 4 with the dotted line 40, which is illustrative of a detection signal that, if it encounters a first animal 19, cannot reach a second animal 18 that is behind the first, thus defining a shadow cone, i.e. a space not reached by the detection signal.

For these reasons the two-dimensional laser scanner 14 must continue to read the same area for a sufficient period, or it must be positioned at different viewpoints, in order to perform multiple scans of the same area.

By way of an analysis software package, the different scans are superimposed and compared, with elimination of all the outlines that have moved during the observation period.

The fact that the normal condition of the animals is that of being in motion, together with the viewpoints from different angles, makes it possible to cancel out the effect of the shadow cones.

Thus a two-dimensional map of the entire surface of the farm is produced, in which the outlines are shown that have occupied the same position over the observation period.

The parameters for determining the recognition of a “dead animal”, such as position tolerance and maximum period of stillness, can vary depending on the type of animal and the farming conditions.

Since the laser scanner is an optical sensor, it could happen, for whatever reason, that a determined area temporarily cannot be reached by laser beams.

In this case, if the area cannot be reached over the entire scanning period of a single mapping, this will be treated in exactly the same way as the outline of a motionless animal if the situation persists in subsequent mappings, the “dead animal” report will thus be given. Using this logic, the monitoring system is particularly reliable, in that it is practically impossible that a dead animal will not be reported: at the most, it may happen that false reports are made in the event of low visibility, but never the contrary.

When the anatomical characteristics and the habits of the animal make it possible, as in the case of laying hens, the laser scanner 14 is positioned so as to execute the detection at the height of the legs of the animal, as shown by the dotted line 41 in FIG. 4; such positioning of the laser scanner 14 at the height of the legs enables a reduction of the effect of shadow cones.

Furthermore, since a healthy animal usually stands on its legs, it is particularly simple to distinguish a standing animal from an animal on the ground, on the basis of the mere size of the outline detected.

FIG. 6 shows a perspective view of a variation of embodiment of the apparatus according to the invention, which is generally designated with the reference numeral 110.

In such variation of embodiment, the scanning means 111 are constituted by a series of telemetry measurement sensors, for example 114, 114a, 114b and 114c, which are supported in a position fixed to the same post-like element 21, mutually spaced apart so that one operates for each one of the rows of cages 15a, 15b and 15c.

In such variation of embodiment, the post-like element 21 is moved for example by belt or chain means 22, or by other, equivalent means, which should be understood as being of a conventional type, as described above, but there are no means for translation from top to bottom, and vice versa, of the two-dimensional scanning means 11, i.e. for a single telemetry measurement sensor, since each row of cages has its own dedicated telemetry measurement sensor.

With such apparatus 110 the scanning of the rows of cages is more frequent and thus more precise.

FIG. 6 shows the areas shaped like circular arcs 50 which are adapted to illustrate the cage areas that are scanned by the telemetry measurement sensors 114, 114a, 114b and 114c.

FIGS. 7 and 8 clearly show the stroke limit of the post-like element 21, where there is a battery charger 28 for the onboard battery 27.

FIG. 7 shows a first electrical contact 29, comprising two contact points 29a and 29b, which is associated with the battery 27, and a second electrical contact 30, associated with the battery charger 28, which comprises two overhanging metallic blades 30a and 30b which are adapted to intercept the corresponding contact points 29a and 29b.

In FIG. 7 the first 29 and second 30 contacts are far apart, in FIG. 8 the contacts are in touch with each other.

On the basis of such premises and observations, it should be understood that the invention also relates to a method for detecting dead animals in a farm by means of an apparatus 10 as described above.

Such method comprises the following operations:
performing periodically a mapping of the space of the farm intended to be occupied by animals raised there,
comparing successive mappings in order to identify any animals that are in the same position in at least two successive mappings,
emitting a signal indicating the presence of a motionless animal.

The mappings are provided by analyzing the path of the rays emitted by a sensor, in order to determine the areas not occupied by animals.

In particular, the mappings are of the two-dimensional type.

The mappings are performed from a fixed point.

Alternatively, and preferably, the mappings are performed from two or more different points.

Alternatively, the mappings can be performed several times from the same preset points.

The mappings are performed with two-dimensional scanning means 11 that are placed at the height of the legs of the animals

With the method according to the invention, it is also envisaged that said signal of the presence of a motionless animal comprises the absolute position of the animal in the farm, so that an operator called to go to remove the dead animal knows immediately where the latter is located in the cages 15.

The method envisages that the report of a motionless animal is ended only when, in a subsequent mapping, the motionless outline no longer appears.

All the data recorded by the system, like the positions of the dead bodies and the extraction times, are recorded and catalogued, i.e. logged in a history file, so that they can be consulted subsequently.

The method according to the invention provides that, at the end of the mapping, the onboard electronic unit 26 establishes a wireless connection to a server 33 that can be reached via a public internet address, the connection being adapted to allow the server 33 to pick up all the gathered data, process them and make them available on the web by way of any internet consultation device, for example a mobile phone 34, a personal computer 35 or a portable computer 36.

It should be understood that the scanning means, other than being two-dimensional, can also be three-dimensional scanning means or even have a single beam, which are in any case used with a method according to the invention.

It should be understood that the invention also relates to the use of a two-dimensional laser scanner 14 for detecting dead animals in a farm, both in cages and on the ground.

In practice it has been found that the invention fully achieves the intended aim and objects.

In fact, with the invention an apparatus for detecting dead animals in a farm has been provided which is capable of overcoming the limitations of monitoring carried out by human personnel, thanks to the use of one or more laser scanners, two-dimensional or three-dimensional, and thanks to the particular method of use.

Furthermore, with the invention a method of detecting dead animals has been provided which is carried out with such apparatus.

In particular, with the invention an apparatus has been provided that operates automatically, with precision, reliably and efficiently, without particular interventions by human personnel, except for management and supervision, and removal of the motionless animal detected.

Furthermore, with the invention an apparatus has been provided, as well as a method for its use, that can be applied easily in already-existing farms, for example in systems for hens, which are already partially provided with the movement means necessary in order to provide an apparatus according to the invention.

The invention, thus conceived, is susceptible of numerous modifications and variations, all of which are within the scope of the appended claims Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. PD2014A000031 from which this application claims priority are incorporated herein by reference.

1-19. (canceled)

20. An apparatus for detecting dead animals in a farm, particularly for farms of laying hens, comprising one or more scanning means arranged, with a corresponding supporting structure, so as to map a space of a farm, said scanning means being connected to an electronic control and management unit that is adapted to process the scans, detecting any presence of motionless animals in said farm space.

21. The apparatus according to claim 20, wherein said scanning means are constituted by at least one two-dimensional laser scanner.

22. The apparatus according to claim 20, wherein said supporting structure comprises a post-like element that is arranged so as to translate in proximity to a series of cages that are arranged on multiple levels of cages and in the direction of their length, said post-like element being moved by way of belt or chain means or by way of other, equivalent means.

23. The apparatus according to claim 22, wherein said post-like element in turn supports means for translation from top to bottom, and vice versa, of the scanning means.

24. The apparatus according to claim 23, wherein said means for translation from top to bottom and vice versa are constituted by a carriage that has on board an electric gearmotor, which is adapted to drive a toothed belt with an omega-shaped path, or other similar and equivalent actuation means.

25. The apparatus according to claim 24, wherein said carriage supports an electronic unit for managing the detected signals and the movement by way of a gearmotor, and an onboard battery adapted to supply power to the scanning means.

26. The apparatus according to claim 25 wherein in proximity to a stroke limit for the post-like element there is a battery charger for the onboard battery, said carriage being provided with an energy transfer system for charging the onboard battery.

27. The apparatus according to claim 22, wherein said scanning means are constituted by a plurality of telemetry measurement sensors, which are supported in a position fixed to the same post-like element, mutually spaced apart so that one operates for each one of the rows of cages.

28. A method of detecting dead animals in a farm by way of an apparatus according to claim 20, comprising the following steps:
performing periodically a mapping of the space of the farm intended to be occupied by animals raised there and contained in cages,
comparing successive mappings in order to identify any animals that are in the same position in at least two successive mappings,
emitting a signal indicating a presence of a motionless animal.

29. The method according to claim 28, wherein said mappings are provided by analyzing a path of the rays emitted by a sensor in order to determine the areas not occupied by animals.

30. The method according to claim 28, wherein said mappings are performed from a fixed point.

31. The method according to claim 28, wherein said mappings are performed from two or more different points.

32. The method according to claim 28, wherein said mappings are performed several times from the same preset points.

33. The method according to claim 28, wherein said mappings are performed with two-dimensional scanning means placed at the height of the legs of the animals.

34. The method according to claim 28, wherein said signal of the presence of a motionless animal comprises the absolute position of the animal in the farm, so that an operator called to go to remove a dead animal knows immediately where said animal is located inside the cages.

35. The method according to claim 28, wherein it interrupts the signalling of a motionless animal only when the motionless outline no longer appears in a subsequent mapping.

36. The method according to claim 28, wherein the data recorded by the system, as well as the positions of dead bodies of the animals and removal times, are recorded and catalogued, i.e., logged in a history file, so that they can be consulted subsequently.

37. The method according to claim 28, wherein at the end of the mapping the electronic unit establishes a wireless connection to a server that can be reached via a public internet address, said connection being adapted to allow the server to receive all the gathered data, process them and make them available on the web by way of any interne consultation device.

38. Use of a telemetry measurement sensor for detecting dead animals in a farm.
